(19) United States
(12) Patent Application Publication
(10) Pub. No.: US 2022/0274289 A1
(43) Pub. Date: Sep. 1, 2022

(54) WET SAW WATER HEATER AND PLUG

(71) Applicants: SHANE BRAMMER, ROCKLIN, CA (US); PAUL BRAMMER, ROCKLIN, CA (US); CRAIG BRAMMER, ROCKLIN, CA (US)

(72) Inventors: SHANE BRAMMER, ROCKLIN, CA (US); PAUL BRAMMER, ROCKLIN, CA (US); CRAIG BRAMMER, ROCKLIN, CA (US)

(21) Appl. No.: 17/572,720

(22) Filed: Jan. 11, 2022

Related U.S. Application Data
(60) Provisional application No. 63/135,863, filed on Jan. 11, 2021.

(51) Int. Cl. B28D 1/02; B28D 7/02; H05B 3/82; H05B 3/04; H05B 3/06

(52) U.S. Cl. CPC B28D 1/02; B28D 7/02; H05B 3/82; H05B 3/04; H05B 3/06; H05B 2203/021

(57) ABSTRACT

A wet saw water heater is described. It is a water heating device that includes necessary components for assembly which are installed onto a wet saw water pan for outdoor winter construction use. For example, the wet saw water heater and plug includes a base component that is formed to selectively connect with a drain hole of the water pan while holding a heating element within the water pain. A heating component having a heating element is attached with the base component and a power cord is connected with the heating element that projects from the base component. Thus, the heating element can be securely affixed within the water pan to heat the water during use.

### CROSS-REFERENCE TO RELATED APPLICATIONS

The present application is a Non-Provisional Utility patent application of U.S. Provisional Application No. 63/135,863, filed on Jan. 11, 2021, entitled, “Wet Saw Water Heater.”

### BACKGROUND OF THE INVENTION

### (1) Field of Invention

The present invention relates to a wet saw water heater and, more particularly, to a water heating element housing that replaces wet saw plug and is installed via the drain whole of the water pan.

### (2) Description of Related Art

Tile setters and stonemasons' primary tool for cutting material is a wet saw. Wet saws use constant circulating water to cool the blade and material that is being cut. This water is pumped from a shallow pan beneath the tile tray up to the blade. When the water comes in contact with the spinning blade it creates a spray of water that comes in contact with the operator and surrounding areas. Although every job condition varies, wet saws are usually placed outside while in use. While operating the wet saw in severe winter conditions the water in the pan can freeze making the wet saw impossible to use. Even in mild conditions, overly cold water on the operator's hands over a full work-day could impair work performance and safety.

There have been some previous attempts to address the issue of cold water. By way of example, some contractors have begun using bucket heaters that are placed into the water pan of the wet saw. While somewhat functional, existing bucket heaters still fail to properly address the issue. For example, the heating elements in existing bucket heaters are not rated to come into direct contact with the water pan, possibly melting the pan or otherwise damaging equipment. Further, the power cord of the bucket heater is an obstacle as it cannot easily sit or drape over the tracks of the tile tray as doing so would impair functionality of the wet saw.

Thus, a continuing need exists for a new and improved wet saw water heater.

### SUMMARY OF INVENTION

The present disclosure is directed to a wet saw water heater and plug. The wet saw water heater and plug includes any necessary components to affix the heater with a wet saw and selectively heat water within a water pan of the wet saw. In one aspect, the wet saw water heater and plug includes a base component that is formed to selectively connect with a drain hole of the water pan while holding a heating element within the water pain. A heating component having a heating element is attached with the base component and a power cord is connected with the heating element that projects from the base component.

In another aspect, the base component includes a housing, a plug cap, and a heating cap.

In yet another aspect, the housing has an entrance, with the heating element being affixed with the heating cap such that the heating cap is affixed within the entrance to the housing.

Further, the housing has an exit with threads proximate the exit, such that the plug cap is operable for screwing onto the threads and affixing the housing against a water pan of a wet saw.

In yet another aspect, the housing has an exit with threads proximate the exit, such that the plug cap is operable for screwing onto the threads and affixing the housing against a water pan of a wet saw.

The present disclosure also provides a method for heating water within a wet saw. The method includes several acts, such as removing a drain plug from a drain hole within a water pan of a wet saw and attaching a water saw heater with the drain hole such that a heating element of the water saw heater is maintained with the water pan.

Attaching the water saw heater with the drain hole further comprises acts of positioning a power cord and threads of the water saw heater through the drain hole, the water saw heater having a housing with a first end and a second end, the first end having the heating element projecting therefrom, with the second end having the threads and power cord projecting therefrom; and attaching a plug cap onto the threads to securely affix the housing against the water pan.

In another aspect, a gasket is secured around the threads and between the water pan and housing to create a water-tight seal.

Additionally, in attaching the water saw heater with the drain hole, the water saw heater is positioned such that the heating element is parallel with a bottom surface of the water pan.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of base components of a wet saw water heater and plug according to various embodiments of the present invention, depicting an assembled housing, plug cap and heating cap;

FIG. 2A is a top-view illustration of the housing;

FIG. 2B is a side-view illustration of the housing;

FIG. 2C is a bottom-view illustration of the housing;

FIG. 2D is a front-view illustration of the housing;

FIG. 2E is a cross-sectional, side-view illustration of the housing, taken from line A-A of FIG. 2D;

FIG. 3A is a top-view illustration of the plug cap;

FIG. 3B is a side-view illustration of the plug gap;

FIG. 3C is a cross-sectional, side-view illustration of the plug cap, taken from line C-C of FIG. 3B;

FIG. 4A is a top-view illustration of the heating cap;

FIG. 4B is a side-view illustration of the heating gap;

FIG. 4C is a cross-sectional, side-view illustration of the heating cap, taken from line B-B of FIG. 4B;

FIG. 5 is an illustration depicting base components as well as heating components that collectively form a wet saw water heater and plug according to various embodiments of the present invention;

FIG. 6 is an illustration depicting the base components and heating components as assembled; and

FIG. 7 is an exploded view illustration, depicting assembly of the base components and heating components.

### DETAILED DESCRIPTION

The present invention relates to a device and a method to create continuous hot water within the water pan of a wet saw for tile and stone mason contractors without obstructing workflow and safety and more particularly to a water heating element housing that replaces the plug and is installed via the drain whole of the water pan. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

As noted above, the present disclosure is directed to a water heating element housing that replaces wet saw plug and is installed via the drain whole of the water pan. Specifically and as shown throughout the figures, the disclosure is directed to base components that can be installed in a wet saw water pan, along with heating components that are used to heat water within the water pan. As an improvement over the prior art, the base components serve as a water heating element housing that can connect via the drain hole of the water pan. The heating components include at least a heating element and power cord. To reduce risk of injury and increase functionality over that of the prior art, the power cord comes out the bottom of the pan so that it does not obstruct the tile tray tracks nor does the heating element come into direct contact with the water pan. Further details are provided below.

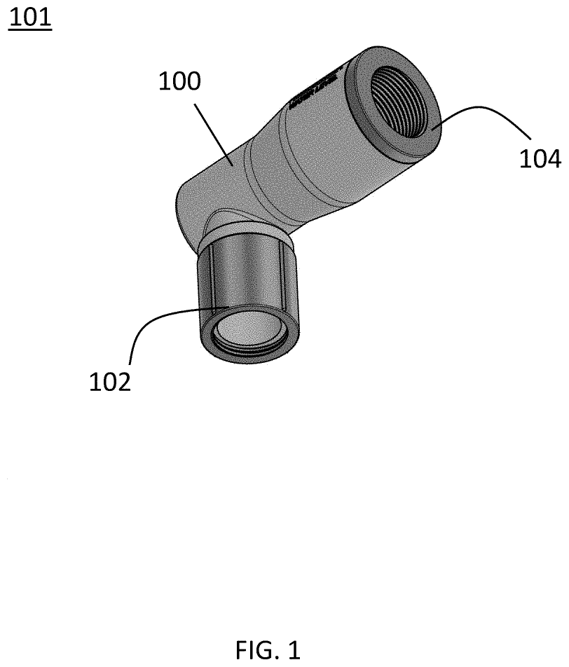

As shown in FIG. 1, the present disclosure provides a base component. The base component 101 is formed in any suitable manner to allow it to be affixed with the drain hole of a wet saw water pan while holding a heating element within the water pan. As a non-limiting example, the base component 101 includes a housing 100, a plug cap 102, and a heating cap 104. As understood by those skilled in the art, gaskets, such as rubber gaskets, can also be selectively used to seal the caps 102 and 104 against the housing 100.

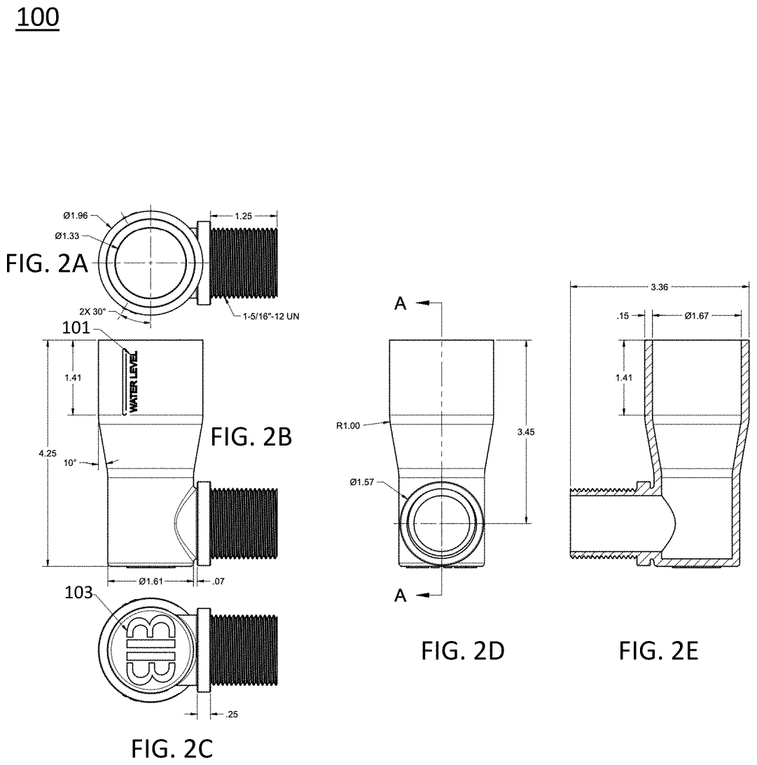

The housing 100 can be formed in any suitable manner to position the heating element within the housing, while directly the electrical cord out through the drain hole. As a non-limiting example, FIGS. 2A through 2E depict various views of an example housing 100. A water level line 101 and logo 103 can also be added to the housing if desired. Notably, the housing 100 is used as a conduit to affix the heating element to the wet saw as well as allow the power cord to pass from the wet saw to the outside of the wet saw for safety and ease of operation.

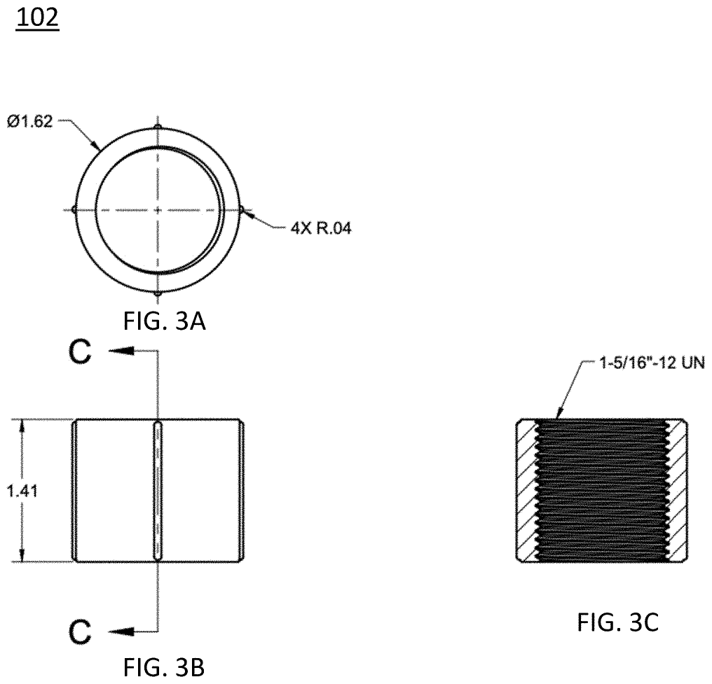

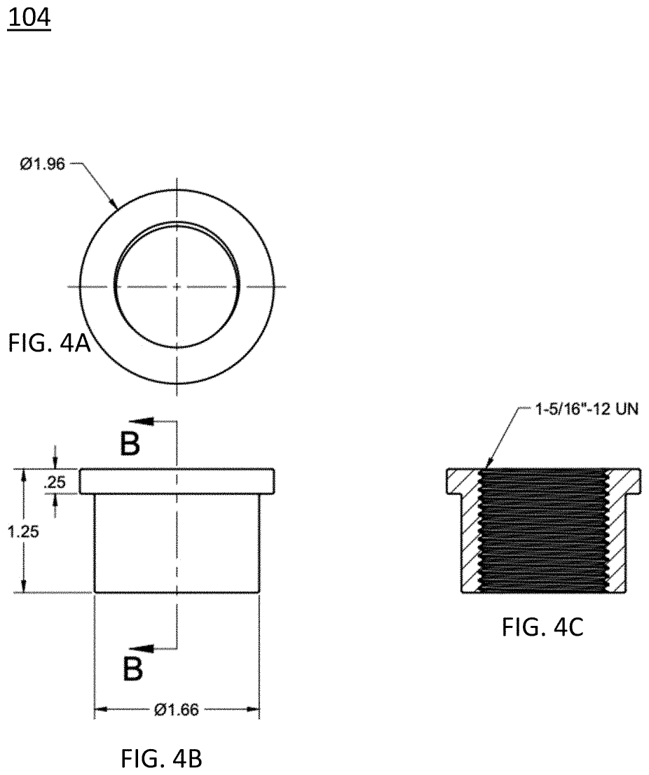

To affix the housing 100 to the drain hole of the wet saw, the invention also includes the plug cap 102. As a non-limiting example, FIGS. 3A through 3C depict various views of an example plug cap 102 that can be used to affix the housing 100 to the drain hole of the wet saw. On the other end of the housing 100 is the heating cap 104. The heating cap 104 is used to secure the heating element within the housing 100. As a non-limiting example, FIGS. 4A through 4C depict various views of an example heating cap 104.

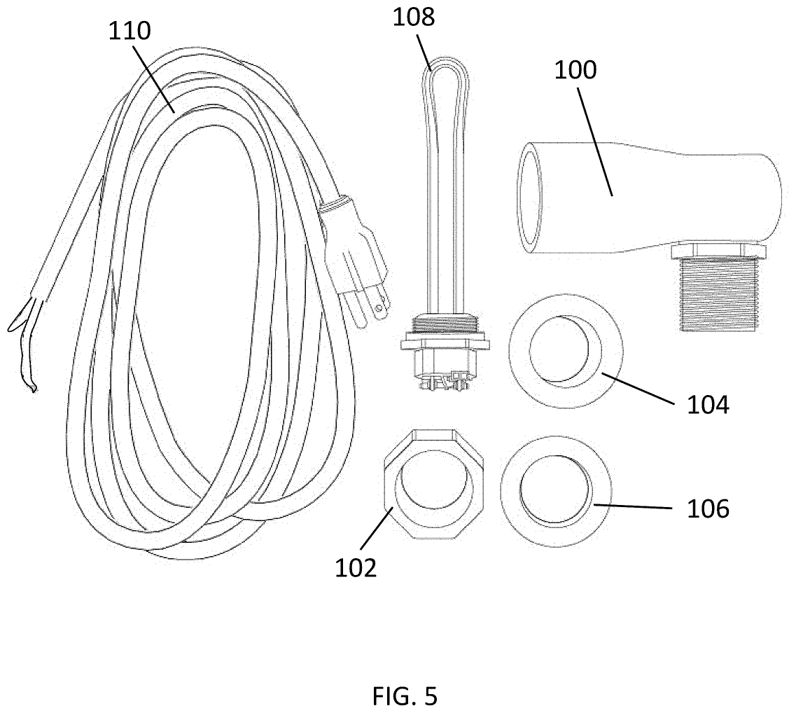

As noted above, the present disclosure also includes heating components that are to be connected to the base component. As shown in FIG. 5, the heating components include a heating element 108 and associated power cord 110. Also shown is a rubber gasket 106 that is used to seal the housing 100 against the drain hole of the water pan (of a wet saw).

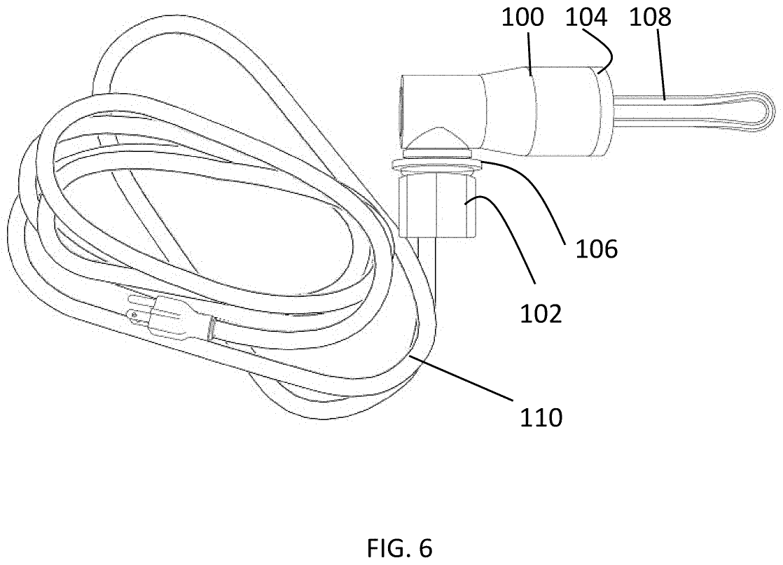

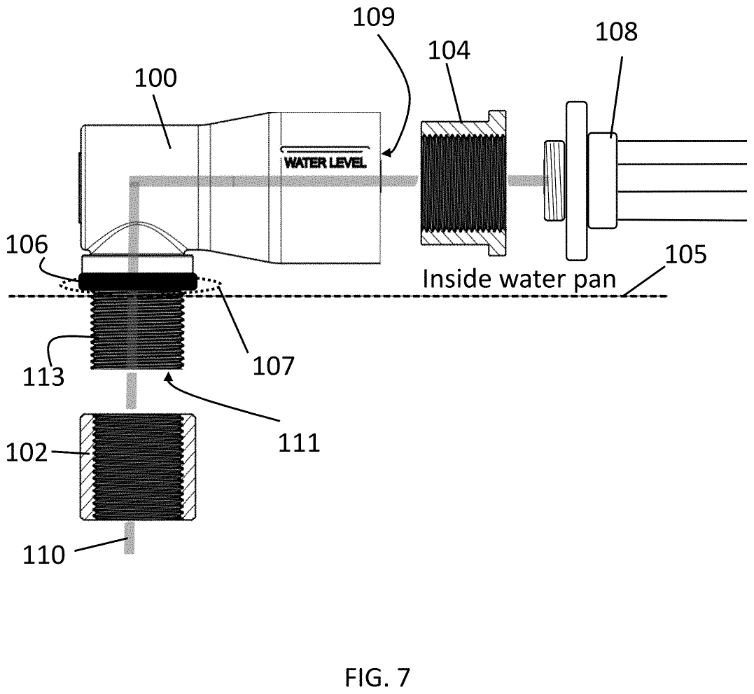

For further understanding, FIGS. 6 and 7 depict the various components as connected (FIG. 6) or being connected (FIG. 7) to one another. As shown and in one aspect, the heating element 108 can be thread into (or otherwise affixed with using glue or any other suitable technique or method) the heating cap 104, with the power cord 110 passing through the heating cap 104, housing 100, gasket 106, and plug cap 102. When the housing 100 is positioned inside the water pan 105, the threads of the housing 100 can be passed through the drain hole 107 (of the water pan 105) and affixed in place using the plug cap 102. Thereafter, the wet saw water heater and plug is ready for use.

As can be understood by those skilled in the art, the various components can be build and assembled using any suitable technique, mechanism or device. As a non-limiting example, to manufacturer the invention, the heating element 108 is screwed into the heating cap 104. Starting at the threads, the power cord 110 is slid through an entrance 109 (first end) of the housing 100 and pulled out through an exit 111 (second end) of the housing 100. If not already attached, wires from power cord 110 can then be soldered onto heating element 108. Once the solder is cooled, a glue can be applied to an inside rim proximate the entrance 109 of the housing 100. Next, the heating cap 104 with the heating element 108 and power cord 110 are slid into and fixedly attached into housing 100 (via the glue). The heating cap 104 is now permanently attached to housing 100 and ready for installation into the water pan 105. The rubber gasket 106 is then slid over the threads 113 of housing 100 until flat with housing 100. To install, the power cord 110 is then then passed through the drain hole 107, with the threads 113 also then being passed through the drain hole 107. Next, the power cord 102 is passed through the plug cap 102, with the plug cap 102 then being screwed onto the threads 113 until water tight seal is achieved against the water pan 105, thereby sealing the drain hole 107. In use, the water pan 105 can then be filled with water up to or past the water line, but not over the edge of the water pan's maximum height. The power cord 110 can be plugged into a power supply to apply heat to the water within the water pan 105. In this aspect, the wet saw water heater and plug is now properly installed and working. The present invention effectively replaces the stock drain plug of the water pan 105.

Installed, the housing 100 re-establishes a water-tight seal so the pan 105 can be filled with water. The heating element 108 and housing 100 sit submerged in water and position the heating element 108 in parallel with a bottom surface of the water pan 105. The heating element connects to a power cord 110 that runs through the housing and out the bottom of the water pan through the drain whole. The base of the housing 100 has a built-in flange and replaceable rubber gasket 106 that tightens to the surface of the water pan 105, re-establishing a water-tight seal.

To uninstall the unit, while water is in the pan 105, unplug the power cord 110 from the power supply. Place a container (e.g., five-gallon bucket) under the drain hole 107 and unscrew the plug cap 102 from the housing 100. Water will then begin to drain from the pan 105 through the drain hole 107. After draining completely, slide the power cord 110 up and through the drain hole 107 for removal.

Finally, while this invention has been described in terms of several embodiments, one of ordinary skill in the art will readily recognize that the invention may have other applications in other environments. For example, although specific dimensions are illustrated, they are provided for illustrative purposes only as it should be explicitly understood that the invention is not intended to be limited thereto. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

1. A wet saw water heater and plug, comprising:
a base component, the base component being formed to selectively connect with a drain hole of a wet saw water pan while holding a heating element within the water pain; and
a heating component, the heating component having a heating element attached with the base component and a power cord connected with the heating element and projecting from the base component.

2. The wet saw as set forth in claim 1, wherein the base component further comprises a housing, a plug cap, and a heating cap.

3. The wet saw as set forth in claim 2, wherein the housing has an entrance, with the heating element being affixed with the heating cap such that the heating cap is affixed within the entrance to the housing.

4. The wet saw as set forth in claim 3, wherein the housing has an exit with threads proximate the exit, such that the plug cap is operable for screwing onto the threads and affixing the housing against a water pan of a wet saw.

5. The wet saw as set forth in claim 2, wherein the housing has an exit with threads proximate the exit, such that the plug cap is operable for screwing onto the threads and affixing the housing against a water pan of a wet saw.

6. A method for heating water within a wet saw, the method comprising acts of:
removing a drain plug from a drain hole within a water pan of a wet saw; and
attaching a water saw heater with the drain hole such that a heating element of the water saw heater is maintained with the water pan.

7. The method as set forth in claim 6, wherein in attaching the water saw heater with the drain hole further comprises acts of:
positioning a power cord and threads of the water saw heater through the drain hole, the water saw heater having a housing with a first end and a second end, the first end having the heating element projecting therefrom, with the second end having the threads and power cord projecting therefrom; and
attaching a plug cap onto the threads to securely affix the housing against the water pan.

8. The method as set forth in claim 7, wherein a gasket is secured around the threads and between the water pan and housing to create a water-tight seal.

9. The method as set forth in claim 8, wherein in attaching the water saw heater with the drain hole, the water saw heater is positioned such that the heating element is parallel with a bottom surface of the water pan.
